(19) United States
(12) Patent Application Publication
(10) Pub. No.: US 2026/0177456 A1
(43) Pub. Date: Jun. 25, 2026

(54) DIAGNOSTIC APPARATUS

(71) Applicant: TOYOTA JIDOSHA KABUSHIKI KAISHA, Toyota-shi (JP)

(72) Inventors: Naoya KOBASHI OKAMOTO, Nagoya-shi (JP); Yosuke ANKO, Miyoshi-shi (JP)

(73) Assignee: TOYOTA JIDOSHA KABUSHIKI KAISHA, Toyota-shi (JP)

(21) Appl. No.: 19/368,080

(22) Filed: Oct. 24, 2025

(30) Foreign Application Priority Data
Oct. 30, 2024 (JP) 2024-190902

(51) Int. Cl. G01M 13/04

(52) U.S. Cl. CPC G01M 13/04

(57) ABSTRACT

The reference number of times is the number of times that stress is applied to an object component before it fails when a specific amount of stress is repeatedly applied thereto. The actual number of times is the number of times that a specific amount of stress is applied thereto. A damage rate, which is a total of the ratio of the actual number to the reference number calculated for each amount of stress applied thereto, is calculated for a failed vehicle. Based on the damage rate calculated for each failed vehicle, a histogram is created where the damage rate is class and the number of failed vehicles is frequency. When the damage rate of the object vehicle is within the peak zone, the diagnostic apparatus diagnoses that the object vehicle will more likely fail than when the damage rate is smaller than the lower limit of the peak zone.

### CROSS-REFERENCE TO RELATED APPLICATION

This application claims priority to Japanese Patent Application No. 2024-190902 filed on Oct. 30, 2024. The disclosure of the above-identified application, including the specification, drawings, and claims, is incorporated by reference herein in its entirety.

### BACKGROUND

### 1. Technical Field

The present disclosure relates to a diagnostic apparatus.

### 2. Description of Related Art

Japanese Unexamined Patent Application Publication No. 2023-139965 (JP 2023-139965 A) describes a diagnostic apparatus. The diagnostic apparatus acquires, from a plurality of vehicles, traveling parameters that are information indicating traveling states of the vehicles.

The diagnostic apparatus calculates similarity between traveling parameters of a given vehicle and traveling parameters of a plurality of other vehicles. The diagnostic apparatus calculates the similarity for all vehicles regarding which the traveling parameters have been acquired.

When the similarity in a vehicle that is an object of diagnosis is a value close to the similarity of vehicles having a failure history, the diagnostic apparatus diagnoses that there is a risk of failure in the object vehicle.

### SUMMARY

As described above, diagnosis that is based on the similarity with a vehicle, in which a failure has occurred, cannot diagnose failure risk for each component.

The diagnostic apparatus for solving the above problem is a diagnostic apparatus for diagnosing a level of probability of occurrence of a failure that is caused by individual properties at time of manufacturing in an object component that is a component that is an object of diagnosis.

A reference count of times is a count of times of stress of a particular magnitude being applied to the object component before the failure occurs in the object component when the stress is repeatedly applied to the object component, that is measured in advance. An actual count of times is a count of times that the stress of the particular magnitude is applied to the object component that is included in a vehicle, that is measured based on traveling history of the vehicle. Based on the reference count of times and the actual count of times, a damage rate that is a total value of a ratio of the actual count of times as to the reference count of times that is calculated for each magnitude of the stress that is applied to the object component that is included in the vehicle, is calculated for a failing vehicle that is a vehicle in which the failure occurred in the object component.

A histogram is compiled based on the damage rate that is calculated for each of a plurality of the failing vehicles, in which the damage rate is taken as a class, and a count of the failed vehicles is a degree.

The diagnostic apparatus includes a processing circuit and a storage device.

The storage device stores information regarding the histogram.

A peak zone is a range of the damage rate that is decided so as to include the class of which the degree is the highest in the histogram.

The processing circuit determines that the failure is more likely to occur with respect to the object component in an object vehicle, when the damage rate in the object vehicle that is a vehicle that is an object of diagnosis is within a range of the peak zone, than when the damage rate in the object vehicle is lower than a lower limit value of the peak zone.

The diagnostic apparatus can diagnose whether there is a risk of failure for each component.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a diagnostic system including a diagnostic apparatus according to an embodiment;

FIG. 2 is a table showing the operating time of the engine according to the combination of the revolutions and the load factor of the vehicle;

FIG. 3 is a histogram used by the diagnostic apparatus of FIG. 1 for diagnosis;

FIG. 4 is a table showing the surface pressure applied to a bearing installed in an engine according to a combination of the revolutions and the load factor of the vehicle;

FIG. 5 is a S-N diagram for an engine-mounted bearing; and

FIG. 6 is a flowchart illustrating a process executed by the diagnostic apparatus of FIG. 1.

### DETAILED DESCRIPTION OF EMBODIMENTS

### Configuration of the Diagnostic System 100

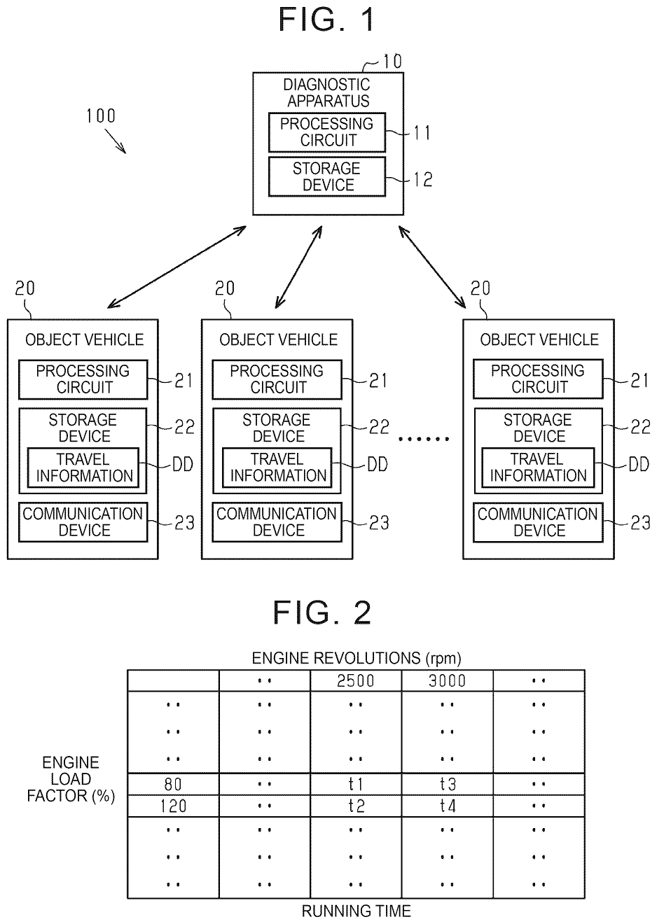

Hereinafter, an embodiment of a diagnostic apparatus will be described with reference to FIGS. 1 to 6.

As illustrated in FIG. 1, the diagnostic system 100 includes a diagnostic apparatus 10 and an object vehicle 20.

As illustrated in FIG. 1, the diagnostic apparatus 10 includes a processing circuit 11 and a storage device 12. The processing circuit 11 executes various kinds of processing by executing a program stored in the storage device 12. The processing circuit 11 includes a processor. The diagnostic apparatus 10 is capable of diagnosing a plurality of object vehicles.

The object vehicle 20 is a vehicle to be diagnosed by the diagnostic apparatus 10. As illustrated in FIG. 1, in the diagnostic system 100, each object vehicle 20 includes a processing circuit 21, a storage device 22, and a communication device 23. The processing circuit 21 executes various kinds of processing by executing a program stored in the storage device 22. The processing circuit 21 includes a processor. Each object vehicle 20 is communicably connected to the diagnostic apparatus 10 through the communication device 23.

The storage device 22 stores traveling information DD. The traveling information DD is information indicating a travel history of the object vehicles 20. Each of the object vehicles 20 stores, in the storage device 22, traveling information DD indicating its own travel history.

FIG. 2 shows an exemplary traveling information DD stored in the storage device 22. FIG. 2 shows the time in which the engine is operated for each combination of the revolutions and the engine load factor. In FIG. 2, the operating hours of the engine are t1 when the revolutions is 2500 rpm and the engine load factor is 80 percent. In FIG. 2, the operating hours of the engine are t2 when the revolutions is 2500 rpm and the engine load factor is 120 percent. In FIG. 2, the operating hours of the engine are t3 when the revolutions is 3000 rpm and the engine load factor is 80 percent. In FIG. 2, the operating hours of the engine are t4 when the revolutions is 3000 rpm and the engine load factor is 120 percent.

The information stored by the storage device 22 as the traveling information DD is not limited to the information illustrated in FIG. 2. For example, the storage device 22 may store the number of times the engine is operated, the number of times the engine is suddenly braked, and the like as the traveling information DD.

### Outline of Diagnosis by the Diagnostic Apparatus 10

The diagnostic apparatus 10 diagnoses, in the object vehicle 20, the object component that is a component to be diagnosed, the high or low possibility that a failure will occur. At this time, the failure diagnosed by the diagnostic apparatus 10 is a failure caused by individual properties at the time of manufacture of the object component.

In the present embodiment, the diagnostic apparatus 10 uses a bearing attached to a crankshaft included in an engine of the object vehicle 20 as an object component. The bearings installed in the engine may be contaminated with minute foreign matters such as cutting debris at the time of manufacturing the engine. The diagnostic apparatus 10 diagnoses, with respect to a bearing included in the object vehicle 20, a high or low possibility of occurrence of a failure caused by a foreign substance mixed at the time of manufacturing the engine.

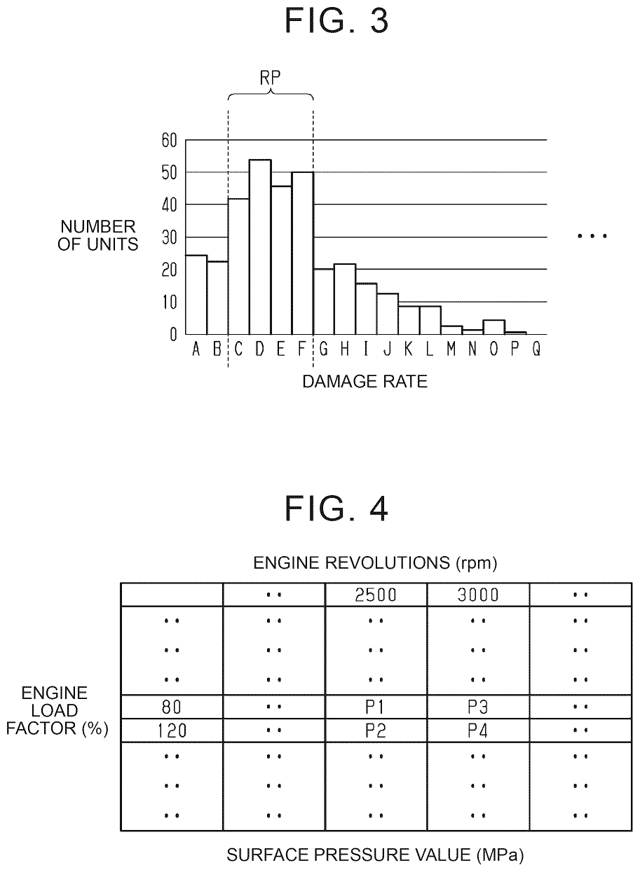

The diagnostic apparatus 10 performs diagnosis on the object component based on information on the histogram created in advance. FIG. 3 shows a histogram used by the diagnostic apparatus 10 in diagnosis.

As illustrated in FIG. 3, in the histogram, the damage rate is set as a class, and the number of failed vehicles is set as a frequency. In FIG. 3, 17 classes from A to Q are shown. A is a class having the smallest damage rate among A to Q. Q is a class having the highest damage rate among A to Q. A failed vehicle is a vehicle in which an object component has failed. In the present embodiment, the failed vehicle is a vehicle in which the bearing of the engine has failed.

### Calculation Method of Damage Rate

In order to create the histogram, a damage rate is calculated for each of the plurality of failed vehicles. Hereinafter, a method of calculating the damage rate will be described.

The damage rate is calculated based on the reference number and the actual number.

The actual number of times is the number of times that a specific amount of stress is applied to an object component included in the vehicle. The amount of stress applied to the bearing is the surface pressure value applied to the bearing. That is, in the diagnostic apparatus 10, the actual number of times is the number of times the stress is applied to the bearing at a specific surface pressure value.

FIG. 4 shows a surface pressure value of stress applied to a bearing installed in an engine according to a combination of a rotational speed of the engine included in the vehicle and a load factor. The surface pressure value shown in FIG. 4 is measured in advance in order to calculate the damage rate.

In FIG. 4, the surface pressure value applied to the bearings at a revolutions of 2500 rpm and an engine load factor of 80 percent is P1. In FIG. 4, the surface pressure value applied to the bearings with the revolutions being 2500 rpm and the engine load factor being 120 percent is P2. In FIG. 4, the surface pressure value applied to the bearings at a revolutions of 3000 rpm and an engine load factor of 80 percent is P3. In FIG. 4, the surface pressure value applied to the bearings with the revolutions being 3000 rpm and the engine load factor being 120 percent is P4.

The actual number of times is measured for each amount of stress. The surface pressure value applied to the bearing varies depending on the combination of the revolutions and the load factor. That is, the actual number of times is measured for each combination of the revolutions and the load factor.

The bearings are stressed each time the fuel burns in the cylinder and the crankshaft rotates. In one cylinder, combustion of fuel occurs one time every two revolutions of the crankshaft of the engine.

In the diagnostic system 100, data as shown in FIG. 2 is measured for a failed vehicle until the bearing fails. The actual number of times can be observed from the operating time of the engine corresponding to the combination of the revolutions and the load factor shown in FIG. 2. Specifically, the actual number of times is calculated from the following equation.

Actual number=Running time of engine×Revolutions of engine per unit time/2 Mathematical Formula 1

In the above formula, the number of times that stress is applied to the bearing from the nearest cylinder is defined as the actual number of times.

As described above, the diagnostic apparatus 10 can calculate the number of times that stress is applied to the bearing for each surface pressure value by calculating the number of times that stress is applied to the bearing for each combination of the revolutions and the load factor. The diagnostic apparatus 10 observes the number of stresses for each surface pressure value calculated in this manner as the actual number of stresses.

The reference number of times is the number of times that stress is applied to an object component before the object component fails when a specific amount of stress is repeatedly applied to the object component. The reference number of times is measured in advance in order to calculate the damage rate.

FIG. 5 is a S-N diagram illustrating the number of stresses applied to a bearing before the bearing fails when a particular surface pressure value stress is repeatedly applied to the bearing. In FIG. 5, the number of stressed bearings before a failure occurs is shown.

Note that when the data shown in FIG. 5 is measured, a bearing in which a foreign substance of a constant size is mixed is used for any surface pressure value. For example, when measuring the surface pressure value shown in FIG. 5, bearings containing foreign matters of 0.2 mm size are used.

FIG. 5 shows that when a stress of P2 magnitude is repeatedly applied to the bearing, the bearing fails when the stress is applied N times. In addition, FIG. 5 shows that when stress of a surface pressure value of 100 MPa or less is applied, the bearing does not fail even when stress is applied many times.

In FIG. 5, the number of stresses applied to the bearing before the bearing fails when the bearing is repeatedly subjected to stresses having a surface pressure value of a specific size is summarized for each surface pressure value in the bearing mixed with foreign matters. The diagnostic apparatus 10 uses the number of times of each surface pressure value as a reference number of times.

As described above, in the diagnostic system 100, the actual number of times and the reference number of times are measured for each surface pressure value. The damage rate is a total value of the ratio of the actual number of times to the reference number calculated for each amount of stress applied to the object component included in the vehicle.

For example, as shown in FIG. 2, the operating hours of the engine are t2 when the revolutions is 2500 rpm and the engine load factor is 120 percent. Then, when the revolutions is 2500 rpm and the engine load factor is 120 percent, the surface pressure value of the stress applied to the engine is P2. Therefore, referring to FIGS. 2 and 4, the actual number of times when the surface pressure value is P2 is calculated by using the mathematical expression shown in Equation 1. Further, as shown in FIG. 5, the reference number of times when the surface pressure value is P2 is N. A ratio of the actual number of times to the reference number of times when the surface pressure value is P2 can be calculated based on the actual number of times calculated in this way and the reference number of times.

On the other hand, as shown in FIG. 5, when the surface pressure value is P1, since the bearings do not fail, the reference number of times cannot be measured. In the diagnostic system 100, the ratio of the actual number of times to the reference number of times is not calculated for the surface pressure value for which the reference number of times cannot be measured.

As described above, by referring to the data of FIGS. 2, 4, and 5, the ratio of the actual number of times to the reference number of times can be calculated for each surface pressure value. Then, the damage rate can be calculated by summing the ratios calculated in this way.

### Histogram Overview

In the diagnostic system 100, a histogram as shown in FIG. 3 is created based on the damage rate calculated by the above-described method. The diagnostic apparatus 10 stores information related to the histogram as illustrated in FIG. 3 in the storage device 12. Note that the diagnostic apparatus 10 may store information on the histogram created by itself or may store information on the histogram already created.

As shown in FIG. 3, a peak zone RP is set to a class in the histogram. peak zone RP is the extent of the damage rate determined to include the highest frequency class in the histogram. In FIG. 3, the range of classes from C to F is the peak zone.

### Processing Executed by the Diagnostic Apparatus 10

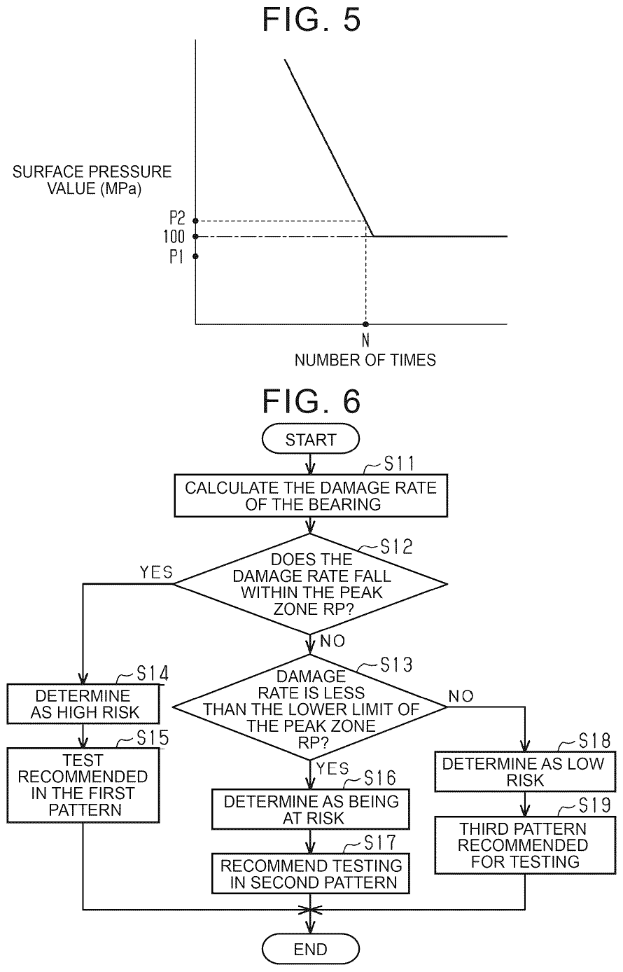

FIG. 6 illustrates an aspect of a series of processes executed by the processing circuit 11 of the diagnostic apparatus 10. The processing circuit 11 executes a series of processing illustrated in FIG. 6 when the traveling information DD of the object vehicle 20 is acquired. For example, the diagnostic apparatus 10 acquires the traveling information DD through communication with the object vehicles 20.

In S11 process, the processing circuit 11 calculates the damage rate of the bearings in the object vehicles 20 based on the acquired traveling information DD. After calculating the damage rate, the processing circuit 11 advances the processing to S12.

In S12 process, the processing circuit 11 determines whether or not the damage rate of the object vehicles 20 is within the peak zone RP in the histogram.

When the processing circuit 11 determines in S12 processing that the damage rate of the object vehicles 20 is within the peak zone RP (S12: YES), the processing proceeds to S14. In S14 process, the processing circuit 11 determines that the bearings included in the object vehicles 20 are highly likely to fail. Thereafter, the processing circuit 11 advances the processing to S15.

After performing the diagnosis of the object vehicle 20, the diagnostic apparatus 10 recommends the user of the object vehicle 20 to inspect the object component based on the result of the diagnosis. At this time, the diagnostic apparatus 10 displays an image indicating that the inspection of the object component is recommended for the user of the object vehicle 20. For example, the diagnostic apparatus 10 displays images indicating that the examination of the object component is recommended in HMI(Human Machine Interface of the object vehicle 20. For example, the diagnostic apparatus 10 may display an image indicating that the inspection of the object component is recommended on the portable information terminal of the user of the object vehicle 20.

The higher the risk of a failure occurring in the object component, the higher the urgency of the inspection. There are three types of modes in which the diagnostic apparatus 10 displays an image to a user: a first pattern, a second pattern, and a third pattern. In the aspect of displaying the image, the urgency of the inspection is high in the order of the first pattern, the second pattern, and the third pattern from the higher side.

The diagnostic apparatus 10 strongly recommends the examination as the urgency of the examination increases. The diagnostic apparatus 10 changes the contents of the message described in the image to content that strongly recommends the examination as the degree of urgency of the examination increases. The diagnostic apparatus 10 increases the frequency of displaying an image as the degree of urgency of the examination increases.

In S15 process, the processing circuit 11 recommends the user of the object vehicle 20 to inspect in the first pattern. Thereafter, the processing circuit 11 ends the series of processing illustrated in FIG. 6.

When the processing circuit 11 determines in S12 processing that the damage rate of the object vehicles 20 is not within the peak zone RP (S12: NO), the processing proceeds to S13. In S13 process, the processing circuit 11 determines whether or not the damage rate of the object vehicles 20 is less than the lower limit of the peak zone RP.

When the processing circuit 11 determines in S13 processing that the damage rate of the object vehicles 20 is less than the lower limit of the peak zone RP (S13: YES), the processing proceeds to S16.

When the damage rate of the object vehicle 20 is smaller than the lower limit of the peak zone RP, it can be inferred that the accumulation of damage due to stress in the object component is not large. In S16 process, the processing circuit 11 determines that the bearings included in the object vehicles 20 are at a moderate risk of failure. In other words, in S16 process, the processing circuit 11 determines that the risk of failure of the bearing included in the object vehicle 20 is lower than that in S14 process and higher than that in S18 process described later. Thereafter, the processing circuit 11 advances the processing to S17.

In S17 process, the processing circuit 11 recommends the user of the object vehicle 20 to inspect in the second pattern. Thereafter, the processing circuit 11 ends the series of processing illustrated in FIG. 6.

When the processing circuit 11 determines in S13 processing that the damage rate of the object vehicles 20 is not less than the lower limit of the peak zone RP (S13: YES), the processing proceeds to S18. In other words, the processing circuit 11 advances the processing to S18 when the damage rate of the object vehicles 20 is larger than the upper limit of the peak zone RP.

When the damage rate of the object vehicle 20 is larger than the upper limit of the peak zone RP, it indicates that no failure has occurred even when the damage rate increases. Therefore, in the object vehicle 20, it is considered that the influence of the properties provided at the time of manufacture is small. More specifically, it is considered that the foreign matter mixed in the bearing is small, and there is a low possibility that a failure caused by the foreign matter occurs.

In S18 process, the processing circuit 11 determines that the bearings included in the object vehicles 20 are less likely to fail. In other words, in S18 process, the processing circuit 11 determines that the bearings included in the object vehicles 20 are less likely to fail than in S14 process and S16 process. Thereafter, the processing circuit 11 advances the processing to S19.

In S19 process, the processing circuit 11 recommends the user of the object vehicle 20 to inspect in the third pattern. Thereafter, the processing circuit 11 ends the series of processing illustrated in FIG. 6.

### Operation of This Embodiment

The diagnostic apparatus 10 diagnoses a high or low probability of failure of an object component included in the object vehicle 20 by using a damage rate calculated based on the number of times that stress is applied to the object component in the object vehicle 20.

### Effect of This Embodiment

(1) The diagnostic apparatus 10 can diagnose the presence or absence of a risk of a failure for each component.

(2) The damage rate of the object vehicles 20 may be larger than the upper limit in the peak zone RP. In this case, the processing circuit 11 determines that the possibility of a failure occurring in the object component in the object vehicle 20 is lower than in the case where the damage rate in the object vehicle 20 is smaller than the lower limit of the peak zone RP.

When the damage rate is larger than the upper limit of the peak zone RP, it is presumed that the effect of the properties provided at the time of manufacturing is small. Therefore, when the damage rate of the object vehicle 20 is larger than the upper limit of the peak zone RP, the object component included in the object vehicle 20 is considered to be an individual in which a failure caused by individual properties is unlikely to occur. When the damage rate of the object vehicles 20 is larger than the upper limit of the peak zone RP, the diagnostic apparatus 10 determines that the possibility of a failure occurring is low. As a result, the diagnostic apparatus 10 can determine the object component having a low possibility of failure in diagnosis.

(3) The damage rate of the object vehicles 20 may be larger than the upper limit in the peak zone RP. In this case, the processing circuit 11 recommends the user of the object vehicle 20 to inspect the object component less frequently than the case where the damage rate of the object vehicle 20 is smaller than the lower limit of the peak zone RP.

The diagnostic apparatus 10 lowers the frequency of recommending the inspection when the object vehicle 20 is an individual in which a failure is unlikely to occur. As a result, the diagnostic apparatus 10 can appropriately change the frequency at which the examination is recommended in accordance with the properties of the individual.

(4) The diagnostic apparatus 10 uses a bearing attached to a crankshaft included in an engine of the object vehicle 20 as an object component. The diagnostic apparatus 10 observes a damage rate of a bearing attached to the engine. As a result, the diagnostic apparatus 10 can diagnose a high or low possibility that the bearing fails.

(5) The amount of stress applied to the bearing is the surface pressure value applied to the bearing. The reference number of bearings is measured in advance for each surface pressure value in a state where foreign matter is mixed in the bearings. For each combination of engine load and revolutions per hour, the surface pressure value applied to the bearing is measured in advance. On the basis of the operating time of the engine in the vehicle measured for each combination, the number of times that stress is applied to the bearing for each surface pressure value corresponding to the combination is observed as the actual number of times. The storage device 12 stores information related to the histogram created by using the reference number and the actual number.

### Example of Change

The diagnostic apparatus 10 observes the surface pressure value applied to the bearing. As a result, the diagnostic apparatus 10 can diagnose the presence or absence of a risk of a failure in the bearing.

The present embodiment can be modified and implemented as follows. The present embodiment and modification examples described below may be carried out in combination of each other within a technically consistent range.

In the diagnostic system 100, the mode in which the actual number of times is calculated is not limited to the mode shown in Equation 1 above. In the above-described embodiment, the number of stresses applied to each bearing at a specific surface pressure value is defined as the actual number of stresses. On the other hand, it is conceivable that the number of times that stress is applied to any one of the plurality of bearings included in the engine at a specific surface pressure value is set as the actual number of times.

In an engine employing a plurality of cylinders, combustion of fuel is generated in any one of the plurality of cylinders each time the engine rotates. Therefore, in a case where the number of times that stress is applied to any one of the bearings included in the engine at a specific surface pressure value is set as the actual number of times, it is conceivable that the number of revolutions per time of the engine is not divided by 2.

In the above-described embodiment, as shown in FIG. 5, the number of times that stress is applied to one bearing before a failure occurs is set as a reference number. In a case where the number of times that stress is applied to any of the bearings included in the engine at a specific surface pressure value is set as the actual number of times, the reference number is, for example, the number of times that the engine has rotated until any of the bearings fails.

In the above-described embodiment, the diagnostic apparatus 10 acquires the traveling information DD from the object vehicles 20, and then calculates the damage rate by itself. On the other hand, instead of calculating the damage rate, the diagnostic apparatus 10 may acquire the already calculated damage rate from another device.

In the above-described embodiment, the damage rate of the object vehicles 20 may be larger than the upper limit of the peak zone RP. In this case, the diagnostic apparatus 10 determines that the object component is less likely to fail than in a case where the damage rate of the object vehicle 20 is smaller than the lower limit of the peak zone RP. On the other hand, when the damage rate of the object vehicle 20 is larger than the upper limit value of the peak zone RP, the diagnostic apparatus 10 may determine that there is the same risk as when the damage rate of the object vehicle 20 is smaller than the lower limit value of the peak zone RP.

In the above-described embodiment, the diagnostic apparatus 10 changes the mode in which the inspection is recommended in accordance with the height of the urgency of the inspection in the object vehicle 20. The diagnostic apparatus 10 may not change the mode in which the inspection is recommended in accordance with the height of the urgency level of the inspection in the object vehicle 20. For example, when the damage rate of the object vehicle 20 is larger than the upper limit value of the peak zone RP, the diagnostic apparatus 10 may recommend inspecting the object component at the same frequency as when the damage rate of the object vehicle 20 is smaller than the lower limit value of the peak zone RP.

In the above-described embodiment, the diagnostic apparatus 10 includes a bearing attached to a crankshaft of an engine as an object component. The component that can be the object component is not limited to a bearing. For example, the diagnostic apparatus 10 may diagnose a high or low risk of a failure caused by a low accuracy of quenching, with respect to a metal component in which a quenching operation is included in a manufacturing process and a variation in the accuracy of quenching is generated.

What is claimed is:

1. A diagnostic apparatus for diagnosing a level of probability of occurrence of a failure that is caused by individual properties at time of manufacturing in an object component that is a component that is an object of diagnosis, wherein,
based on a reference count of times that is a count of times of stress of a particular magnitude being applied to the object component before the failure occurs in the object component when the stress is repeatedly applied to the object component, that is measured in advance, and an actual count of times that is a count of times that the stress of the particular magnitude is applied to the object component that is included in a vehicle, that is measured based on traveling history of the vehicle, a damage rate that is a total value of a ratio of the actual count of times as to the reference count of times that is calculated for each magnitude of the stress that is applied to the object component that is included in the vehicle was calculated for a failing vehicle that is a vehicle in which the failure occurred in the object component, and
a histogram is compiled based on the damage rate that is calculated for each of a plurality of the failing vehicles, in which the damage rate is taken as a class, and a count of the failed vehicles is a degree,
the diagnostic apparatus comprising: a processing circuit; and a storage device, in which
the storage device stores information regarding the histogram, and
when the damage rate in an object vehicle that is a vehicle that is an object of diagnosis is within a range of a peak zone that is a range of the damage rate that is decided so as to include the class of which the degree is highest in the histogram, the processing circuit determines that the failure is more likely to occur with respect to the object component in the object vehicle than when the damage rate in the object vehicle is lower than a lower limit value of the peak zone.

2. The diagnostic apparatus according to claim 1, wherein the processing circuit determines that, when the damage rate in the object vehicle is higher than an upper limit value in the peak zone, the failure is less likely to occur with respect to the object component in the object vehicle than when the damage rate in the object vehicle is lower than the lower limit value of the peak zone.

3. The diagnostic apparatus according to claim 2, wherein when the damage rate in the object vehicle is higher than the upper limit value in the peak zone, the processing circuit reduces a frequency of recommending inspection of the object component to a user of the object vehicle, as compared to when the damage rate in the object vehicle is lower than the lower limit value of the peak zone.

4. The diagnostic apparatus according to claim 1, wherein a bearing that is attached to a crankshaft that is provided to an engine of the object vehicle is the object component.

5. The diagnostic apparatus according to claim 4, wherein
the magnitude of stress that is applied to the bearing is a surface pressure value that is applied to the bearing,
the reference count of times in the bearing is measured in advance for each surface pressure value, in a state of inclusion of foreign matter in the bearing,
the surface pressure value that is applied to the bearing is measured in advance for each combination of engine load on the engine and revolutions per unit time of the engine,
the count of times that the stress is applied to the bearing is observed as the actual count of times, for each of the surface pressure values corresponding to the combinations, based on operating time of the engine in the vehicle that is measured for each of the combinations, and
the storage device stores information related to the histogram that is created using the reference count of times and the actual count of times.
